(19) United States
(12) Patent Application Publication
(10) Pub. No.: US 2004/0141822 A1
(43) Pub. Date: Jul. 22, 2004

(54) Drill Jigs For Installing Door Closer And Door Closer Arm

(76) Inventor: Ned H. Hiller, Owings Mills, MD (US)

Correspondence Address: Andrew Floam, 1826 Briar Ridge Court, McLean, VA, 22101

(21) Appl. No.: 10/707,423

(22) Filed: Dec. 12, 2003

Related U.S. Application Data
(60) Provisional application No. 60/319,795, filed on Dec. 17, 2002.

(51) Int. Cl. B23B 47/28

(52) U.S. Cl. 408/115 R

(57) ABSTRACT

A door closer jig and a door closer arm jig to facilitate the installation of a door closer system. The door closer jig aligns the holes in a door frame header to mount the door closer mechanism, and the closer arm jig aligns the holes in a door for the closer arm. The jigs have drill bushings to enable an installer to mark, spot and drilling of holes in the door frame header and closer arm. The jigs save significant time during installation of the door closer systems.

### CROSS REFERENCE TO RELATED APPLICATIONS

This application claims priority to U.S. Provisional Application No. 60/319,795 filed Dec. 17, 2002, the entirety of which is incorporated herein by reference.

### BACKGROUND OF INVENTION

Door closer systems are used to bias closed commercial doors, such as glass, steel, and wood doors. Installation of door closer systems requires proper alignment of the door closer mechanism and the door closer arm. The speed with which a door closer system is installed, together with the door itself, greatly affects the overall cost of door installations. While various templates are known to assist door installers, there is room for improvement.

### SUMMARY OF INVENTION

Briefly, a door closer jig and a door closer arm jig are provided to facilitate the installation of a door closer system.

The door closer jig aligns the holes in a door frame header to mount the door closer mechanism, and the closer arm jig aligns the holes in a door for the closer arm. The jigs have drill bushings to enable an installer to mark, spot and drilling of holes in the door frame header and closer arm. The jigs save significant time during installation of the door closer systems.

### BRIEF DESCRIPTION OF DRAWINGS

FIGS. 1 and 2 are diagrams showing a door closer system used to bias a door to close within a door frame.

FIG. 3 is a front view of a door frame header and a door closer jig, and showing how the door closer jig is used to spot and drill holes in the door frame header.

FIG. 4 is a front view of a closer arm jig.

FIG. 5 is a perspective view of the closer arm jig and a door.

FIG. 6 is a front view of a door with the closer arm jig positioned to spot and drill holes in the door for the closer arm.

### DETAILED DESCRIPTION

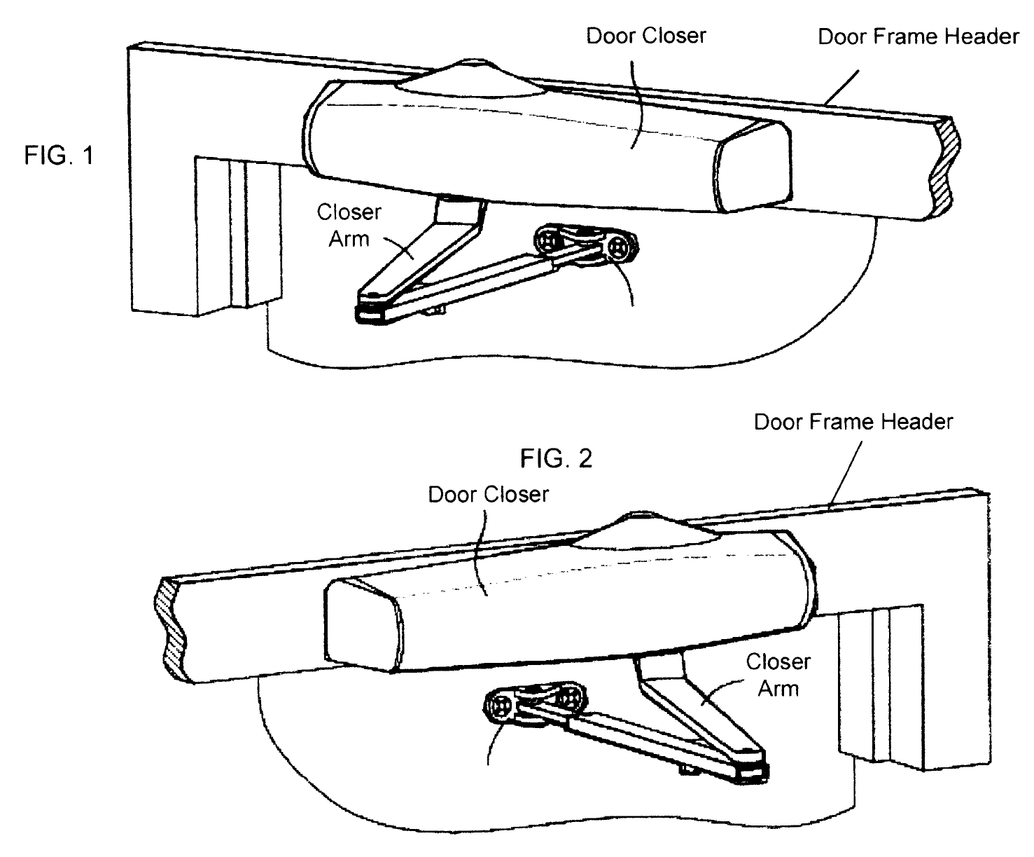

FIGS. 1 and 2 illustrate the general environment for the drill jigs. These figures show a door closer system in which a door closer is attached to a surface of a door frame header and a door closer arm is attached to the door itself. A drill jig is provided to mark and spot the holes to be drilled into the door header for the door closer, and a drill jig is provided to mark and spot the holes to be drilled into the door for the door arm. FIGS. 1 and 2 show a door closer configuration whereby the door closer is attached to the door frame header and the door closer arm is attached to the door. The concepts of the drill jigs described herein may also apply to a door closer configuration wherein the door closer is attached to the door and the door closer arm is attached to the door frame header.

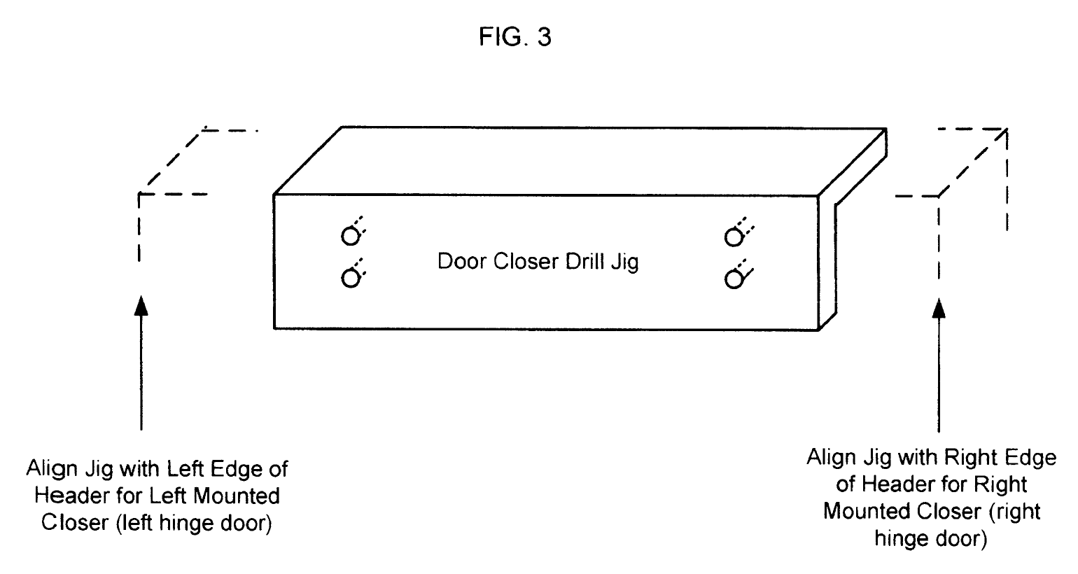

Turning to FIG. 3, the door closer drill jig is shown. It is essentially an L-shaped member having a vertical surface and a horizontal surface. There are two sets of holes in the door closer drill jig, each with a drill bushing therein. The holes are positioned at the appropriate locations to position the door closer mechanism on the door frame header. When the door is a left hinged door, the drill jig is positioned so that the horizontal surface rests on the top of the frame header and aligned with the left edge of the door frame header. The jig can be removed and the holes are ready to receive screws to mount the door closer. The four holes are then appropriately positioned on the door frame header and the holes can be marked, spotted and drilled (either partially or completely) with the jig in place. Similarly, the drill jig is positioned aligned with the right edge for a right hinged door.

If the door closer drill jig is for a 3 foot door, the vertical surface is 20 long, and the holes are positioned 9 1/16 inches on-center horizontally, and ¾ inch on-center vertically. The vertical surface is 1¾ inches wide and the horizontal surface is 1¾-2 inches wide, for example. If the door closer drill jig is for a 3′-6″ door, the vertically surface is lengthened to be 24 inches long, with the added length equally placed on both sides.

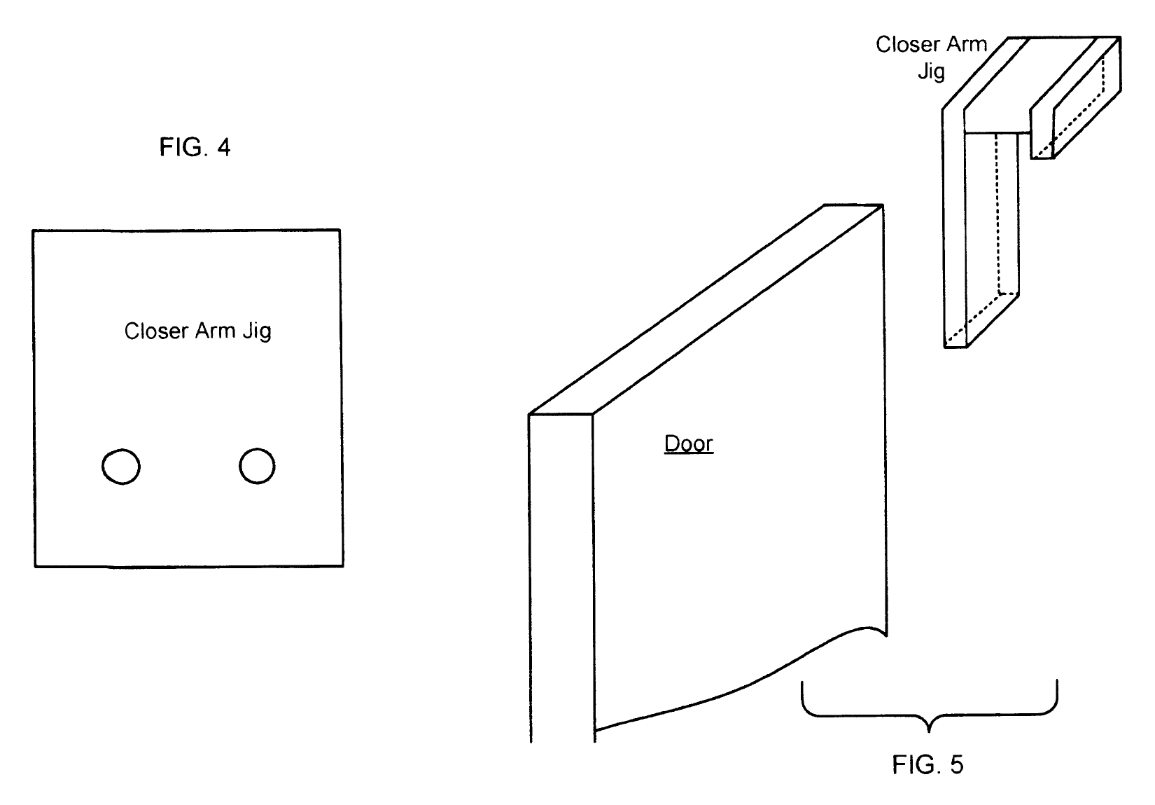

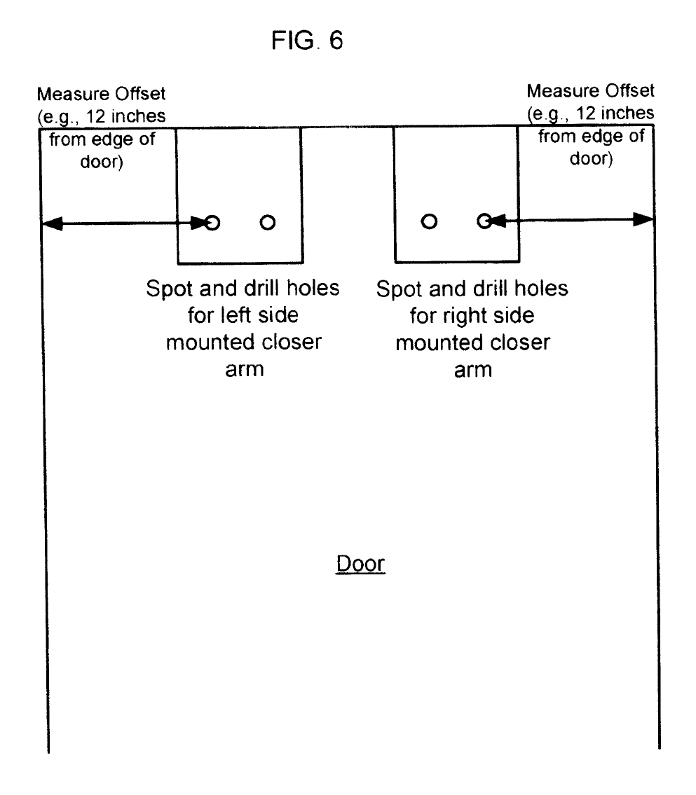

Referring to FIGS. 4-6, the closer arm drill jig is shown together with a door with which the drill jig is used. The closer arm jig is a U-shaped device having two vertical arms and a horizontal spacer. The vertical arms are spaced apart by the spacer appropriate for the width of the door. One of the vertical arms (a front face) is longer than the other. There are two holes provided through the longer vertical arm (front face) of the closer arm jig. For example, the width of the front vertical arm is 2½ inches, the length is 5¼ inches, and the holes are 1¾ on-center horizontally, and two inches up from the bottom edge of the longer vertical arm. The other vertical arm is ¾-1 inch long. The spacer is, for example, ⅛ inch wide and ½ inch in length. Drill bushings (such as #7 drill bushings) are affixed in the holes. In operation, the closer arm jig is positioned over the top of the door (e.g., the door web in the case of a glass door) 12 inches from an edge of the door (left edge or right edge, depending on the hinge location of the door) to the center of the closest drill bushing (as shown in FIG. 6). The holes are marked, spotted and drilled on the face of the door where the closer arm is to be mounted through the drill bushings in the longer vertical arm. The closer arm jig is removed and the closer arm is screwed into the door using the holes made with the jig.

Unlike known templates which are temporarily or permanently attached to the door frame header and door to mark hole locations, the jigs described herein are used to spot, mark and drill the holes. The jigs can be kept in place to start or completely drill the holes. The jigs are reused for other additional installations.

The above description is intended by way of example only.

1. A drill jig system for spotting drill holes to install a door closer system on a door frame header and door, comprising:
a. a door closer jig comprising an L-shaped member having a vertical surface and a horizontal surface, the vertical surface having holes therein at positions corresponding to desired positions measured from an vertical edge of a door frame header for mounting screws for a door closer mechanism on the door frame header; and
b. a door closer arm jig comprising a U-shaped member having two vertical arms that fit over a top of a door, at least one of the arms having a surface with holes at positions corresponding to desired positions measured from an edge of a door for mounting screws for a door closer arm associated with the door closer onto the door.

2. The drill jig system of claim 1, and further comprising drill bushings positioned in the holes of the door closer jig and the door closer arm jig.

3. The drill jig system of claim 1, wherein the holes in the door closer arm jig are positioned to spot holes in the door when the door closer arm jig is positioned a predetermined distance from a vertical edge of the door.

4. The drill jig system of claim 1, wherein the vertical arm of the door closer arm drill jig is longer than the other vertical arm.

5. The drill jig system of claim 4, wherein the vertical arms of the door closer arm drill jig are spaced apart by a distance sufficient to fit over a top of a door.

6. A drill jig for spotting drill holes to install a door closer mechanism on a door frame header comprising an L-shaped member having a vertical surface and a horizontal surface, the vertical surface having holes therein at positions corresponding to desired positions measured from an vertical edge of a door frame header for mounting screws for a door closer mechanism on the door frame header.

7. A drill jig for spotting drill holes to install a door closer arm on a door comprising a U-shaped member having two vertical arms that fit over a top of a door, at least one of the arms having a surface with holes at positions corresponding to desired positions measured from an edge of a door for mounting screws for a door closer arm associated with the door closer onto the door.
